(19) United States
(12) Patent Application Publication
(10) Pub. No.: US 2018/0115555 A1
(43) Pub. Date: Apr. 26, 2018

(54) AUTHENTICATING DATA TRANSFER

(71) Applicant: VALIDIC, INC., Durham, NC (US)

(72) Inventors: Drew Schiller, Chapel Hill, NC (US); Julius Francisco, Paranaque City (PH)

(21) Appl. No.: 15/850,008

(22) Filed: Dec. 21, 2017

Related U.S. Application Data
(62) Division of application No. 14/934,088, filed on Nov. 5, 2015.
(60) Provisional application No. 62/075,313, filed on Nov. 5, 2014.

(51) Int. Cl. H04L 29/06; H04L 29/08

(52) U.S. Cl. CPC H04L 63/102; H04L 63/0884; H04L 63/083; H04L 67/327

(57) ABSTRACT

In an embodiment, a method for authenticating data transfer is provided. A user-agent is redirected between an enterprise, an intermediary platform, and an application server.

### CROSS-REFERENCE TO RELATED APPLICATIONS

This application is a Divisional of co-pending U.S. patent application Ser. No. 14/934,088 entitled AUTHENTICATING DATA TRANSFER, filed Nov. 5, 2015, and claims the benefit of the filing date of U.S. provisional patent application Ser. No. 62/075,313 entitled AUTHENTICATING DATA TRANSFER, filed Nov. 5, 2014, the entire contents of which are incorporated herein by reference for all purposes.

### TECHNICAL FIELD

This application relates to authentication and, more particularly, to authentication of client access to server resources.

### BACKGROUND

The OAuth 2.0 protocol permits a “resource owner” entity to grant a “client” entity access to resources hosted by a “resource server” entity. The resource owner entity may authenticate itself with the resource server entity, then grant the client entity access to the resources. OAuth 2.0 is described in RFC 6749, a document published by the Internet Engineering Task Force. The entire contents of RFC 6749 are incorporated herein by reference for all purposes.

The OAuth 2.0 protocol requires the resource server to validate access tokens and respond to requests for resources. Some entities may be unable or unwilling to offer a resource server which complies with the OAuth 2.0 protocol. Some entities may have no Application Programming Interface (API) for a client to use to request resources. It would be desirable if an alternative protocol did not impose these requirements but could still permit a resource owner to grant a client access to resources hosted by another entity. It would also be desirable if the alternative protocol were similar, from the user's perspective, to the OAuth 2.0 protocol.

### SUMMARY

In an embodiment, a method for authenticating data transfer is provided. A user-agent is redirected between an enterprise, an intermediary platform, and an application server.

### DESCRIPTION OF DRAWINGS

Reference is now made to the following Detailed Description taken in conjunction with the accompanying drawings, in which:

FIG. 1 depicts a system for transferring of private data from a user to an enterprise;

FIG. 2 depicts a system for transferring private data from multiple users to an enterprise;

FIG. 3 depicts a method for authenticating data transfer;

FIG. 4 depicts an alternate method for authenticating data transfer;

FIG. 5 depicts a method for exchanging data when an enterprise registers a new user with an intermediary platform;

FIG. 6 depicts a method for exchanging data when an intermediary platform registers a new app.

FIGS. 7A-7D2 depict the method of FIG. 3 with additional details;

FIG. 8 depicts a method for sending private data after a subscription has been created; and

FIG. 9 depicts a general method for authenticating data transfer.

### DETAILED DESCRIPTION

In the following discussion, numerous specific details are set forth to provide a thorough explanation. However, such specific details are not essential. In other instances, well-known elements have been illustrated in schematic or block diagram form. Additionally, for the most part, specific details within the understanding of persons of ordinary skill in the relevant art have been omitted. Furthermore, health data will be discussed in examples, but the following discussion is not limited to health data.

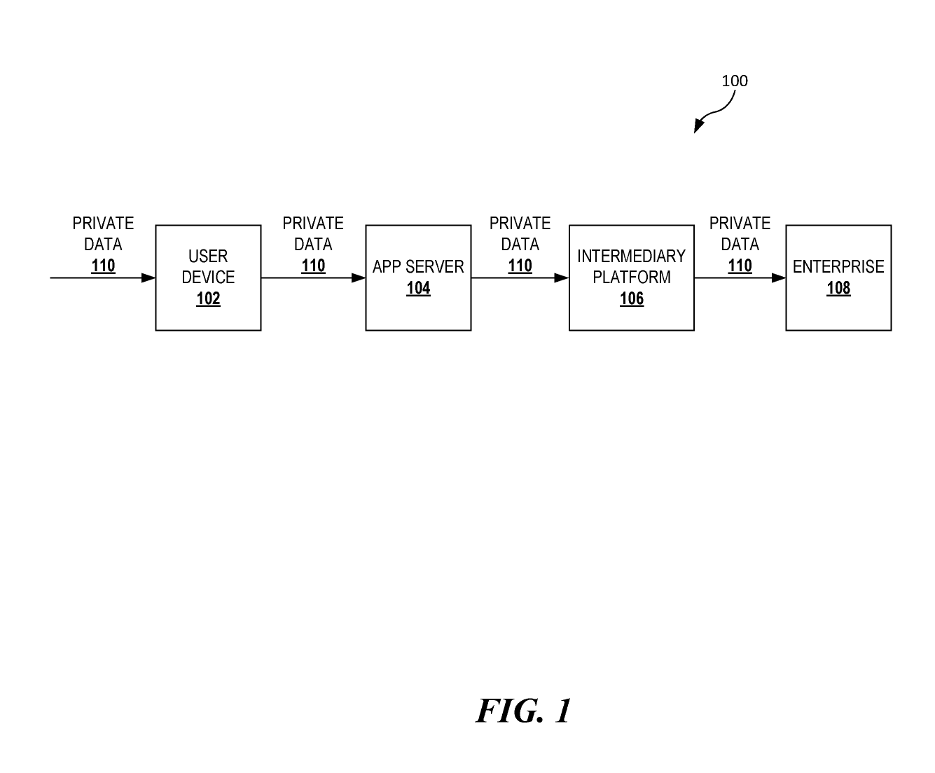

Referring to FIG. 1, depicted is a private data system 100 including a user device 102, an app server 104, an intermediary platform 106, and an enterprise 108. User device 102, app server 104, intermediary platform 106, and enterprise 108 may all be network devices connected by a data network such as the Internet.

A user may operate user device 102. User device 102 may be, for example, a desktop computer, laptop computer, tablet computer, or smartphone. User device 102 may run a software application (“app”) that obtains private data 110. Web apps and mobile apps are examples of possible apps.

Private data 110 may be one or more items of private data. Private data 110 may be data that the user wishes to limit the distribution of. In an embodiment, private data 110 is health data relating to the user's health. A non-exhaustive list of possible health data includes calories consumed, steps taken, and blood glucose. The app could obtain the health data in a variety of ways, such as obtaining data input by the user, obtaining data measured by user device 102, obtaining data from another device such as a pedometer or blood glucose meter, and the like.

The app may send private data 110 to app server 104. App server 104 may be, for example, a server controlled by the developer of the app. If the app is a web app, the app may be running on both user device 102 and app server 104 as is known in the art.

App server 104 may store the private data 110 but allow the user to control access to the data 110. The user may have one or more authentication credentials that authenticate the user to app server 104. The authentication credentials may be a username and password. After the user is authenticated, the user may access private data 110 stored by the app server 104.

Enterprise 108 may wish to access private data 110 with the permission of the user. Where private data 110 is health data, enterprise 108 may be a device of, for example, an employer, a pharmaceutical company, a health insurance company, or another healthcare payer. Enterprise 108 may use intermediary platform 106 to simplify the process of accessing data from a number of users and apps. Intermediary platform 106 may receive private data 110 from app server 104. Enterprise 108 may receive private data 110 from intermediary platform 106.

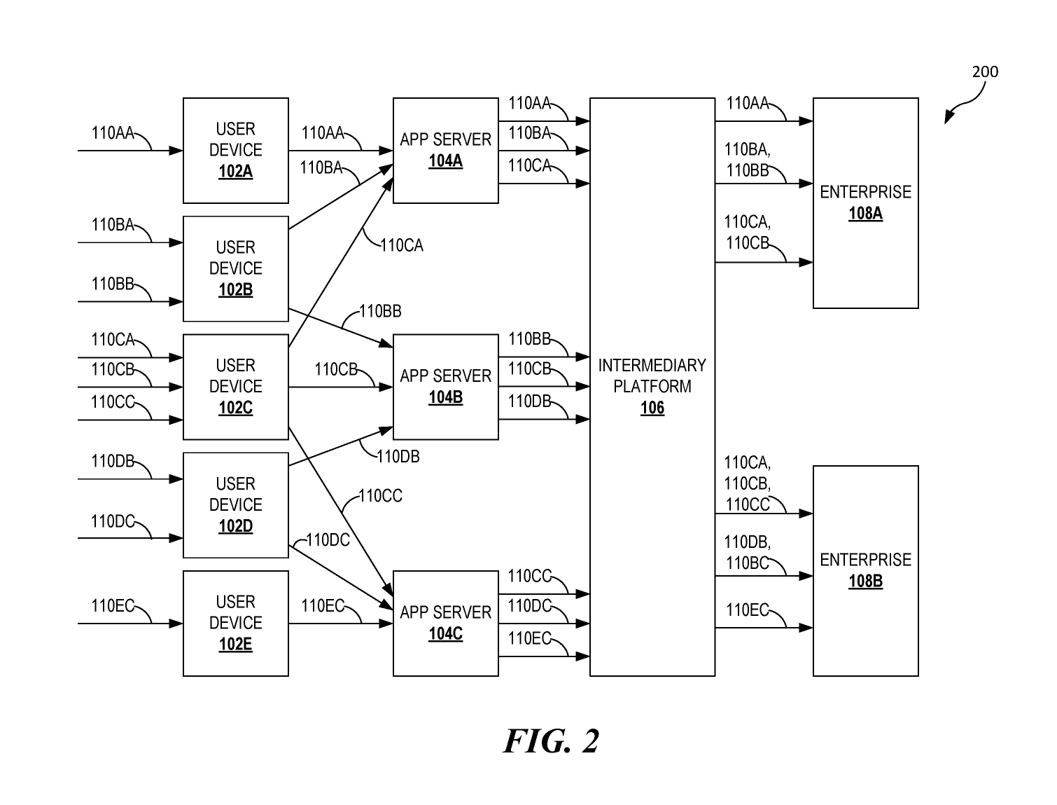

Private data system 100 shows the path taken by private data 110 for a single user device 102. Referring to FIG. 2, depicted is a private data system 200 showing multiple user devices 102A-102E, app servers 104A-104C, and enterprises 108A-108B. Private data system 200 illustrates the advantages of intermediary platform 106 to an enterprise.

User devices 102A-102E, app servers 104A-104C, intermediary platform 106, and enterprises 108A-108B may all be connected by a data network such as the Internet. To facilitate communication across the network, each network device may have a network location such as an Internet Protocol address. Sending data to a network device may be accomplished by sending data to its network location. The network devices may communicate through a protocol such as HyperText Transfer Protocol (HTTP).

In private data system 200, each user device 102A-102E may be associated with a different user. Each user device 102A-102E may run a different set of apps. User device 102A may run an app associated with app server 104A. User device 102B may run apps associated with app servers 104A and 104B. User device 102C may run apps associated with app servers 104A, 104B, and 104C. User device 102D may run apps associated with app servers 104B and 104C. User device 102E may run an app associated with app server 104C. Each app may send private data 110 specific to the user of the corresponding user device 102A-102E to the associated app server 104A-104C.

As an example, the apps associated with app server 104A may allow the users to input calories consumed. The apps associated with app server 104B may connect to pedometers and read steps taken. The apps associated with app server 104C may connect to blood glucose test meters and read blood glucose test results. App server 104A may receive calories consumed by the users, app server 104B may receive steps taken by the users, and app server 104C may receive blood glucose test results. Private data 110AA, 110BA, and 110CA may respectively be calories consumed by the users of user devices 102A, 102B, and 102C. Private data 110BB, 110CB, and 110DB may respectively be steps taken by the users of user devices 102B, 102C, and 102D. Private data 110CC, 110DC, and 110EC may respectively be blood glucose test results of the users of user devices 102B, 102C, and 102D.

Intermediary platform 106 may collect the private data from each app server 104A-104C. Intermediary platform 106 may also organize the private data by user. Enterprises 108A and 108B may then obtain the private data from intermediary platform 108A.

Enterprise 108A may be interested in private data from the users of user devices 102A, 102B, and 102C, but not interested in private data from app server 104C. Enterprise 108B may be interested in private data from users of user devices 102C, 102D, and 102E. Continuing with the previous example, enterprise 108A may be a device of a fitness company monitoring calories consumed and steps taken, but unconcerned with blood glucose. Enterprise 108B may be a device of an insurance company interested in all aspects of its customers' health. Enterprises 108A and 108B may obtain the pertinent private data from intermediary platform 106.

Intermediary platform 106 may provide a single location for enterprises 108A and 108B to obtain private data relating to users. To protect the privacy of users' private data, app servers 104A, 104B, and 104C may provide private data to intermediary platform 106 only with the permission of the user that sent that private data. Each user may have separate authentication credentials for each app server 104A-104C. For example, the user of user device 102C may have a different username and password for each of app servers 104A, 104B, and 104C. For branding reasons, enterprises 108A and 108B may keep the existence of intermediary platform 106 hidden from the users.

For simplicity, the user devices 102A-102E, the app servers 104A-104C, intermediary platform 106, and enterprises 108A-108B are presented herein as though they are single devices. However, multiple devices may be used as is known in the art. For example, user device 102C may be a smartphone running an app associated with app server 104A, a tablet computer running an app associated with app server 104B, and a desktop computer running a web app associated with app server 104C. As another example, app server 104A may be two servers in communication with one another. One server may receive data from user devices 102A-102C and the other server may provide the data to intermediary platform 106.

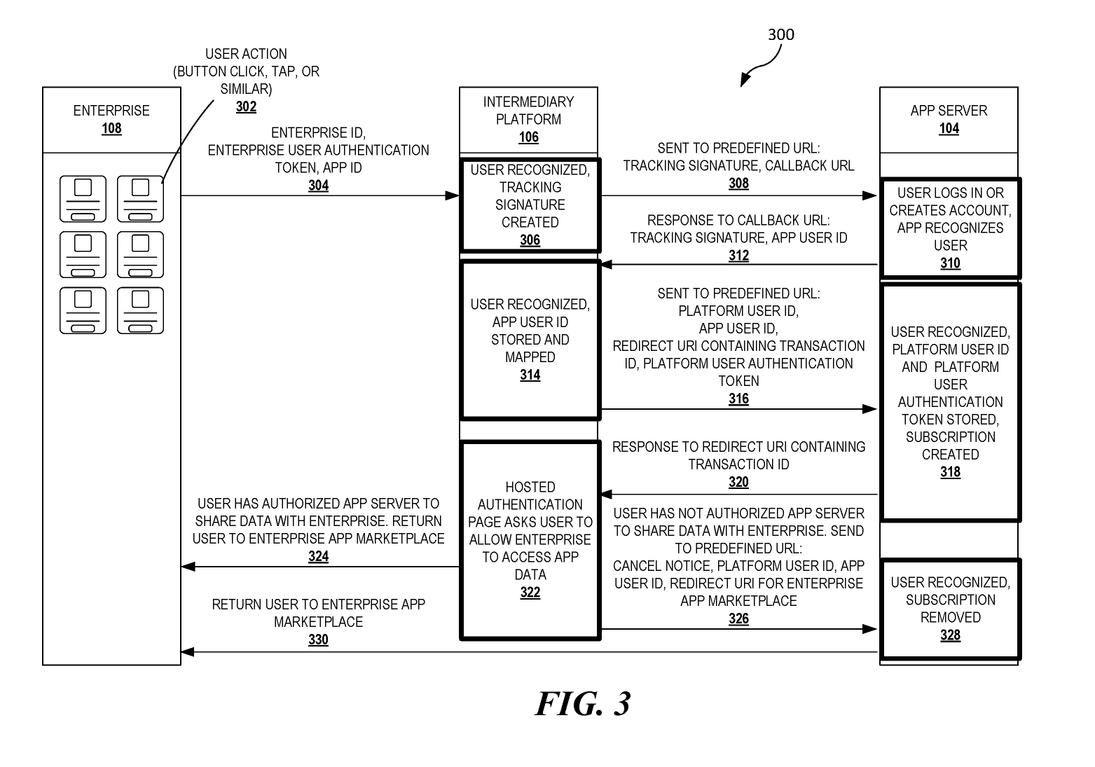

As discussed above, it would be desirable if an alternative to OAuth 2.0 did not impose the same requirements as OAuth 2.0 on the resource server. Referring to FIG. 3, depicted is a method 300 for authenticating data transfer. Method 300 permits a user to authorize app server 104 to send private data to intermediary platform 106. Intermediary platform 106 may act as an agent of enterprise 108.

The user may have a user-agent, such as a web browser or an app published by enterprise 108. Communication between the user and each of enterprise 108, intermediary platform 106, and app server 104 may be performed through the user's user-agent. Communication between enterprise 108, intermediary platform 106, and app server 104 may be accomplished by redirecting the user-agent, such as through HTTP redirection. The role of intermediary platform 106 may be hidden from the user, except that the intermediary platform 106 may interact with the user's user-agent.

Enterprise 108 may have an “app marketplace” web page showing a listing of apps which a user may register with enterprise 108. A “registered” app may be one which enterprise 108 is able to access private data from. A user may be required to authenticate with enterprise 108 to access the app marketplace.

At step 302, the user may choose an app, such as by clicking or tapping on a button for the app. The user's user-agent may send a HTTP GET request to enterprise 108. The HTTP GET request may identify the app. At step 304, the user's user-agent may be redirected to intermediary platform 106. The redirection URI may contain (for example, in a HTTP GET query string) an enterprise ID, identifying enterprise 108, an enterprise user authentication token, identifying the user, and an app ID, identifying the app. Intermediary platform 106 may have previously generated and issued the enterprise ID to enterprise 108 when enterprise 108 registered with intermediary platform 106. Intermediary platform 106 may have previously generated and issued the enterprise user authentication token to enterprise 108 when the enterprise 108 registered the user with intermediary platform 106. In addition to identifying the user, the enterprise user authentication token may also authenticate the enterprise 108 to the intermediary platform 106. Intermediary platform 106 may publish a list of apps and their associated app IDs for enterprise 108 to reference for step 304.

At step 306, intermediary platform 106 may recognize the user from the enterprise user authentication token. The enterprise ID may additionally confirm the identity of the user. In an alternate embodiment, the enterprise ID is not used in steps 304 and 306, and intermediary platform 106 may recognize the user only from the enterprise user authentication token.

Intermediary platform 106 may create a unique “tracking signature” identifying this attempt to obtain authorization from the user. The tracking signature may be a SHA-1 hash value. At step 308, intermediary platform 106 may redirect the user-agent to a predefined URL for the app server 104 of the app. The predefined URL may have been provided to intermediary platform 106 when intermediary platform 106 began supporting data from the app. The URL in the redirection may also contain (for example, in a HTTP GET query string) the tracking signature and a “callback URL” for intermediary platform 106, a URL for app server 104 to return the user-agent to.

At step 310, app server 104 may prompt the user to authenticate with the user's one or more authentication credentials. This is commonly done by asking the user to log in with a username and password. App server 104 may also permit the user to create a new account, which will authenticate the user as the owner of the new account. At step 312, app server 104 may redirect the user's user-agent to the previously specified callback URL for intermediary platform 106. The URL in the redirection may also contain (for example, in a HTTP GET query string) the tracking signature and an app user ID, an identifier by which app server 104 recognizes the user.

At step 314, intermediary platform 106 may recognize the user from the tracking signature. Intermediary platform 106 may store the app user ID and map the app user ID to a platform user ID, an identifier by which intermediary platform 106 recognizes the user. Thus, intermediary platform 106 may subsequently recognize the user from the app user ID.

At step 316, the user-agent may be redirected to a predefined URL for the app server 104 of the app. This predefined URL may be the same predefined URL as at step 308, or may be a different URL. The URL in the redirection may also contain (for example, in a HTTP GET query string) the platform user ID, the app user ID sent at step 312, and a URI containing an identifier of the transaction. The identifier of the transaction may be a unique identifier generated by intermediary platform 106 to identify this authorization from the user. Alternately, the tracking signature generated at 306 may be reused as the identifier of the transaction.

The URL in the redirection may additionally contain a platform user authentication token, a token which identifies the user to intermediary platform 106 and authenticates app server 104 with intermediary platform 106. This platform user authentication token is optional and is for possible later use after method 300.

At step 318, app server 104 may recognize the user from the app user ID in the URL. App server 104 may store the platform user ID and, if included, the platform user authentication token. The platform user ID and platform user authentication token may be associated with the app user ID so that app server 104 may subsequently recognize the user from the platform user ID or the platform user authentication token.

Also at step 318, app server 104 may create a subscription of intermediary platform 106 to the user's data. As will be discussed below, app server 104 may then send the user's data to intermediary platform 106. At step 320, app server 320 may redirect the user-agent to the redirect URI specified at step 316 and containing the transaction ID.

At step 322, intermediary platform 106 may recognize the transaction from the transaction ID. Enterprise 108 may also be identified from the transaction ID. An authentication page hosted by intermediary platform 106 may ask the user to confirm the grant of access to enterprise 108 to access the user's app data. Although a subscription may have already been created at step 318, the prompt may confirm the user intended to create the subscription. The prompt also provides consistency with OAuth 2.0, which similarly requires a user to confirm the user intends to grant access to data. Although the authentication page may be hosted by intermediary platform 106, the authentication page may identify only enterprise 108 and not intermediary platform 106, keeping intermediary platform 106 hidden from the user.

At step 324, if the user confirms the grant of access at step 322, the user-agent may be returned to the app marketplace of enterprise 108. At step 326, if the user cancels the grant of access at step 322, the user-agent may be redirected to a predefined URL for app server 104. This predefined URL may or may not be the same as the predefined URLs in steps 308 and 316. The URL in the redirection may also contain (such as in a HTTP GET query string) a cancel notice, the platform user ID, the app user ID, and a redirect URI for the enterprise app marketplace.

At step 328, app server 104 may recognize the user from either the platform user ID or the app user ID and remove the subscription created at step 318. At step 330, the user-agent may be redirected to the enterprise app marketplace as specified by the redirect URI at step 326.

After the subscription has been created at 318, app server 104 may send user private data to intermediary platform 106. App server 104 may send subsequent user private data as it is received by app server 104. App server 104 may also send previously sent user private data. App server 104 may send private data through HTTP POST requests to a predefined URL for intermediary platform 106. Intermediary platform 106 may use a single predefined URL to receive all private data from any app server.

Each POST request may contain the app ID, the platform user ID, and the data. To authenticate app server 104, each POST request may also contain an app access token specific to the app. The app access token may have been previously provided by intermediary platform 106 to app server 104.

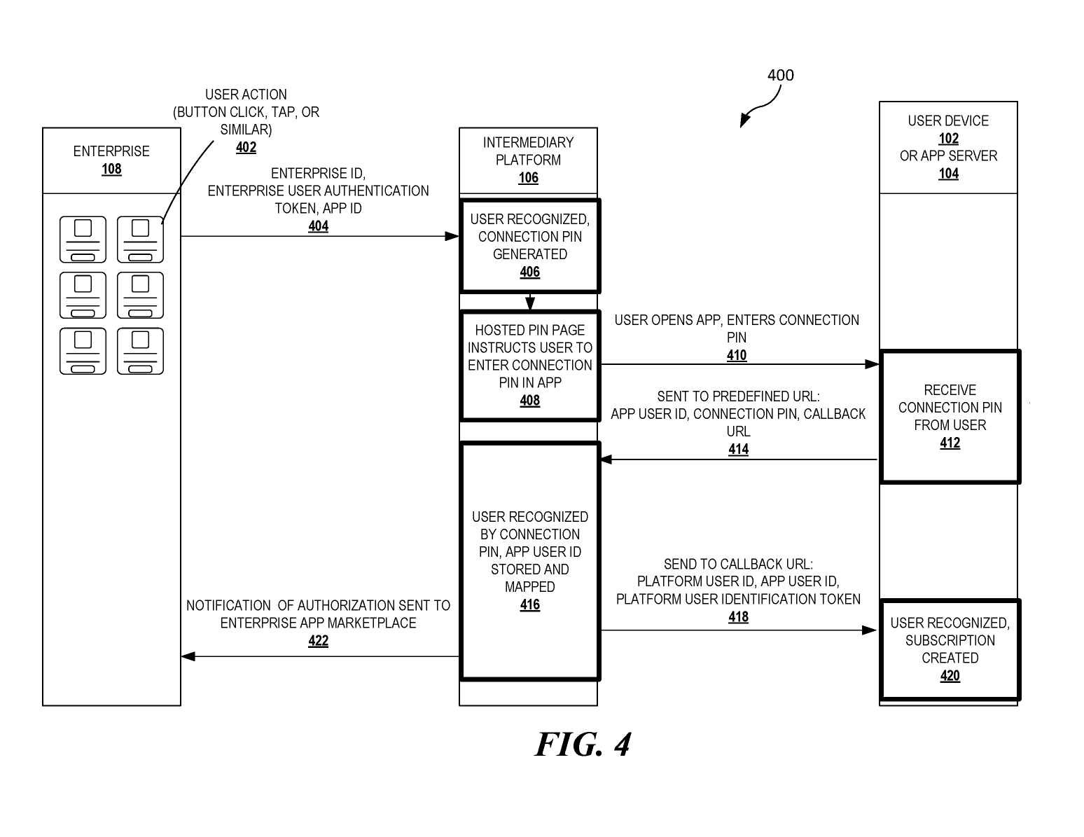

Referring to FIG. 4, depicted is a second method 400 for authenticating data transfer. Method 400 does not require the user to provide authentication credentials. In method 400, app server 104 may receive only a single request from intermediary platform 106. Method 400 is thus suitable for user device 102 to send data directly to intermediary platform 106, without the involvement of any app server 104. An app server 104 may also be involved only to receive the single request and forward it to user device 102, as will be discussed below.

At step 402, a user may select an app to register from the app marketplace of enterprise 108. The user's user-agent may send a HTTP GET request to enterprise 108. At step 404, the user's user-agent may be redirected to intermediary platform 106. As in step 404, the redirection URI may contain (such as in a HTTP GET query string) an enterprise ID, an enterprise user authentication token, identifying the user, and an app ID. At step 406, intermediary platform 106 may recognize the user from the enterprise ID and enterprise user authentication token. In an alternate embodiment, the enterprise ID is not used in steps 404 and 406, and intermediary platform 106 may recognize the user only from the enterprise user authentication token.

Intermediary platform 106 may create a unique “connection PIN” identifying this attempt to obtain authorization from the user. The connection PIN may be a series of alphanumeric characters such as “0123ABCD” which the user can easily copy. At step 408, in response to the user's request to intermediary platform 106 at step 404, intermediary platform 106 may return a “PIN page” hosted by intermediary platform 106. The PIN page may display the connection PIN and instruct the user to enter the connection PIN in the app.

If the app is downloadable and the user has not already downloaded it, the user may download the app. At step 410, the user may run the app and enter the connection PIN. At step 412, the app may receive the connection PIN. The app may be running exclusively on user device 102, or may be a web app running partly on app server 104. At step 414, user device 102 or app server 104 may send the app user ID, the connection PIN, and a callback URL to a predefined URL for the intermediary platform 106. As discussed above, the app user ID may be an identifier by which the app recognizes the user. The callback URL may be a URL which the app may receive a response at. The message sent at step 414 may be in the form of a HTTP GET or POST request.

At 416, intermediary platform 106 may recognize the user from the connection PIN. Intermediary platform 106 may store the app user ID and map the app user ID to a platform user ID, an identifier by which intermediary platform 106 recognizes the user. Thus, intermediary platform 106 may subsequently recognize the user from the app user ID.

At 418, intermediary platform 106 may send a platform user ID, the app user ID, and a platform user authentication token to the callback URL specified at step 414. As in method 300, the platform user authentication token is optional. The message sent at step 418 may be in the form of a HTTP GET or POST request.

In an embodiment, an app server 104 may be used in method 400 solely to receive the message sent at step 418 and forward the message to user device 102. At step 414, user device 102 may send a URL of the app server 104 as the callback URL. Intermediary platform 106 may send the message at step 418 to the app server 104. User device 102 may access to the app server 104 and retrieve the message. Thus, the message at step 418 may be sent from intermediary platform 106 to user device 102 with app server 104 as an intermediary.

At 420, the app may recognize the user from the app user ID. The app may create a subscription of intermediary platform 106 to the user's data. At step 422, intermediary platform 106 may send enterprise 108 a notification that the user has authorized enterprise 108 to access data from the app. The notification may identify the user and the app.

After the subscription has been created at step 420, user device 102 or app server 104 may send private data to intermediary platform 106 using HTTP POST requests as discussed previously with respect to method 300. Where user device 102 sends the private data to intermediary platform 106, each user device may have a separate app authentication token to authenticate that user device. Alternately, all user devices for a single app may share the same app authentication token.

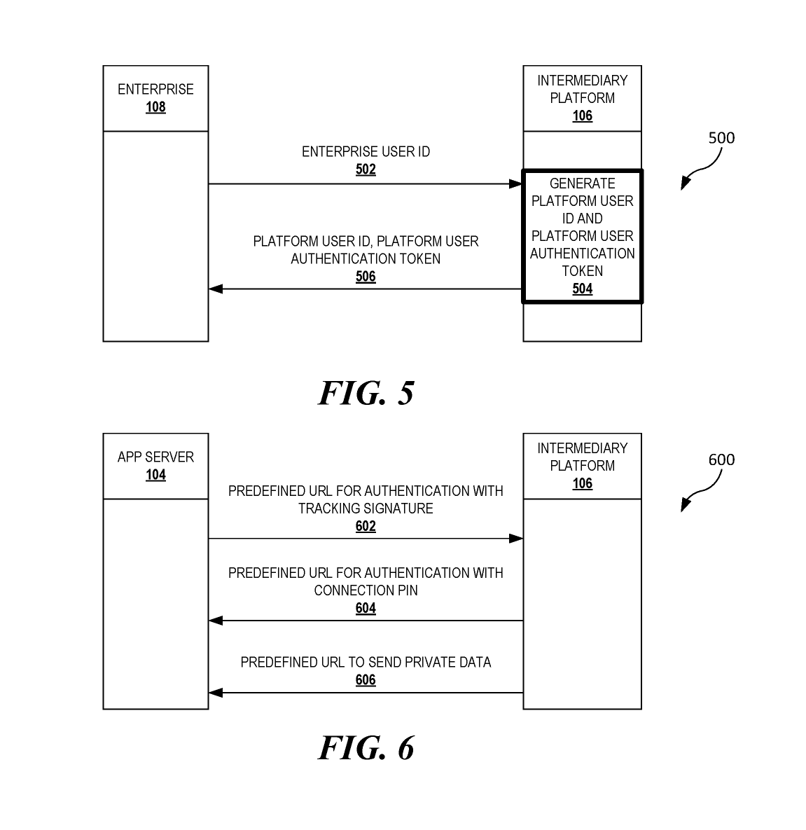

Referring to FIG. 5, depicted is a method 500 for exchanging data when enterprise 108 registers a new user with intermediary platform 106. At step 502, enterprise 108 may send an enterprise user ID to intermediary platform 106. The enterprise user ID may be an identifier of the user to enterprise 108. At step 504, intermediary platform 106 may generate a platform user ID and platform user authentication token. The platform user ID may be an identifier of the user to intermediary platform 106. The platform user authentication token may also be an identifier of the user to intermediary platform 106, but one intended to be kept secret between enterprise 108 and intermediary platform 106. At step 506, intermediary platform 106 may send the platform user ID and platform user authentication token to enterprise 108.

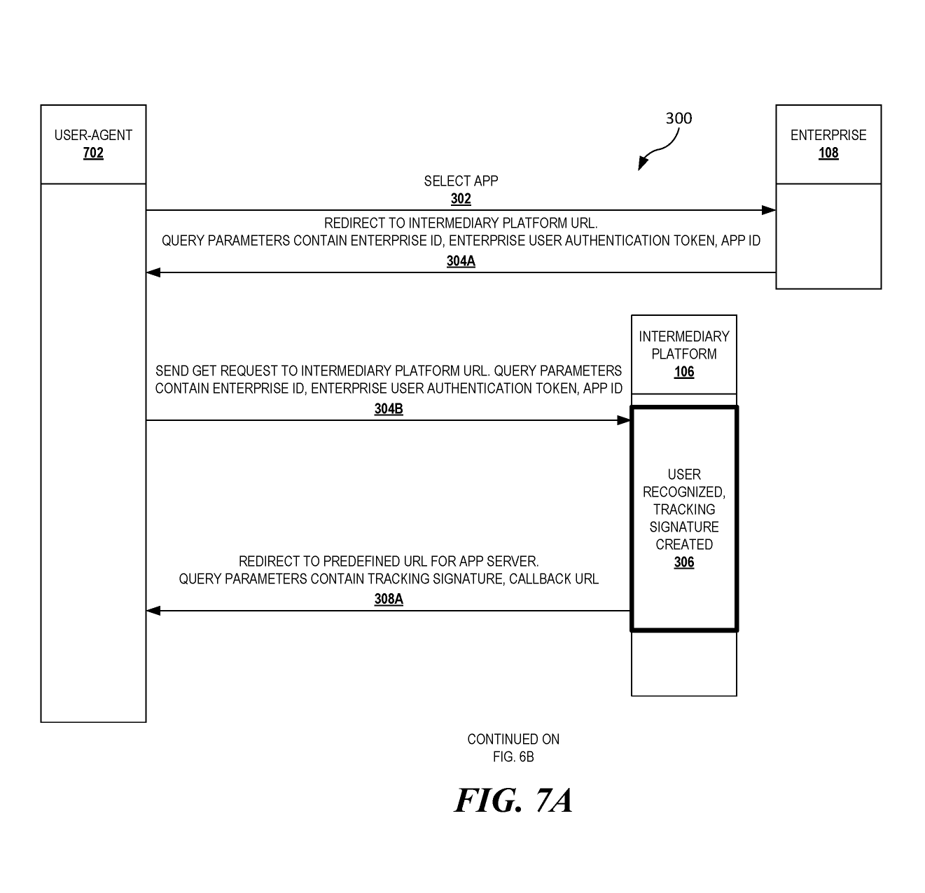

Referring to FIG. 6, depicted is a method 600 for exchanging data when intermediary platform 106 registers a new app. At step 602, if the app supports method 300, user authentication with a tracking signature, app server 104 may send intermediary platform 106 a predefined URL for intermediary platform 106 to redirect user-agents to at step 308. If app server 104 has a separate predefined URL for intermediary platform 106 to redirect user-agents to at step 316, app server 104 may also send that predefined URL. At step 604, if the app supports method 400, user authentication with connection PIN, intermediary platform 106 may send app server 104 a predefined URL for app server 104 to send messages to in step 414. At step 606, intermediary platform 106 may send app server 104 a predefined URL for app server 104 to send user private data to. Method 600 may only need to be performed once per app, regardless of how many user or user devices 102 run that app. If a user device 102 interacts directly with intermediary platform 106 in method 400, app server 104 may send necessary information to the user device 102.

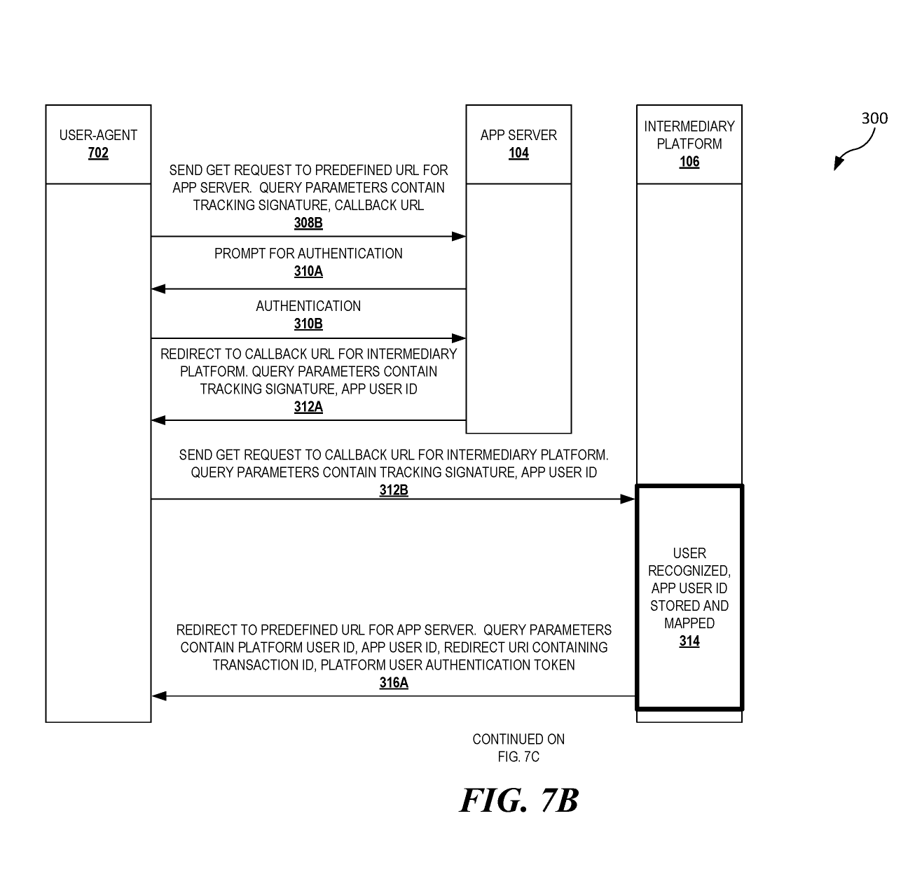

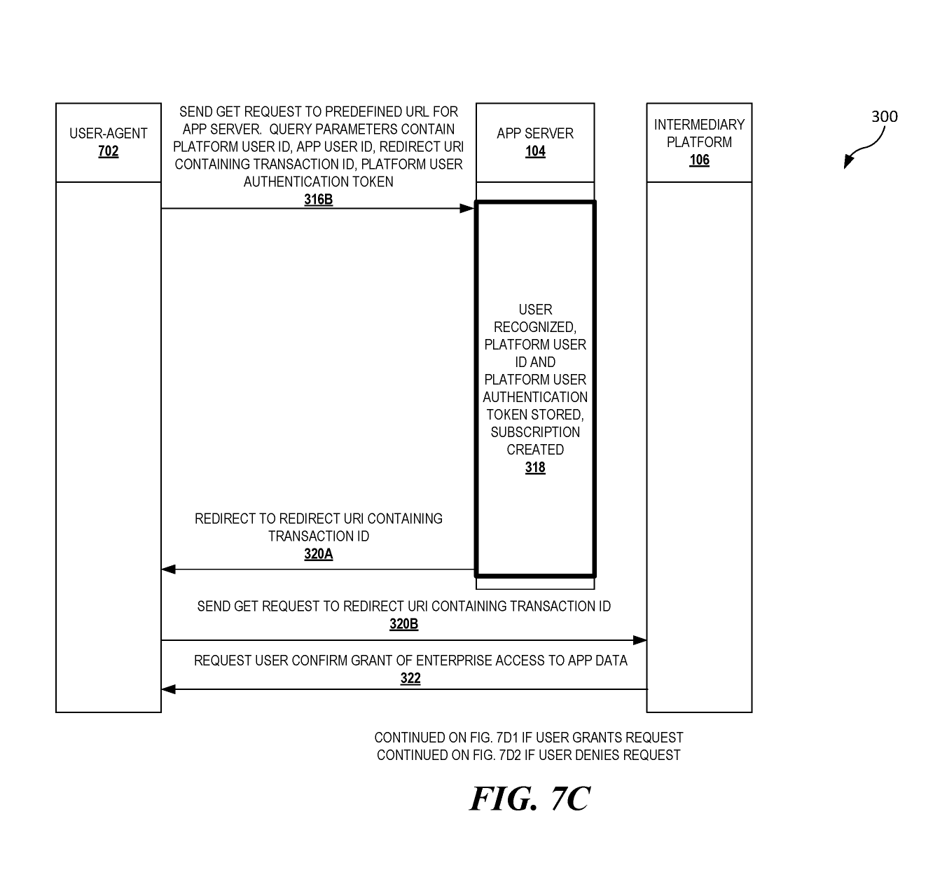

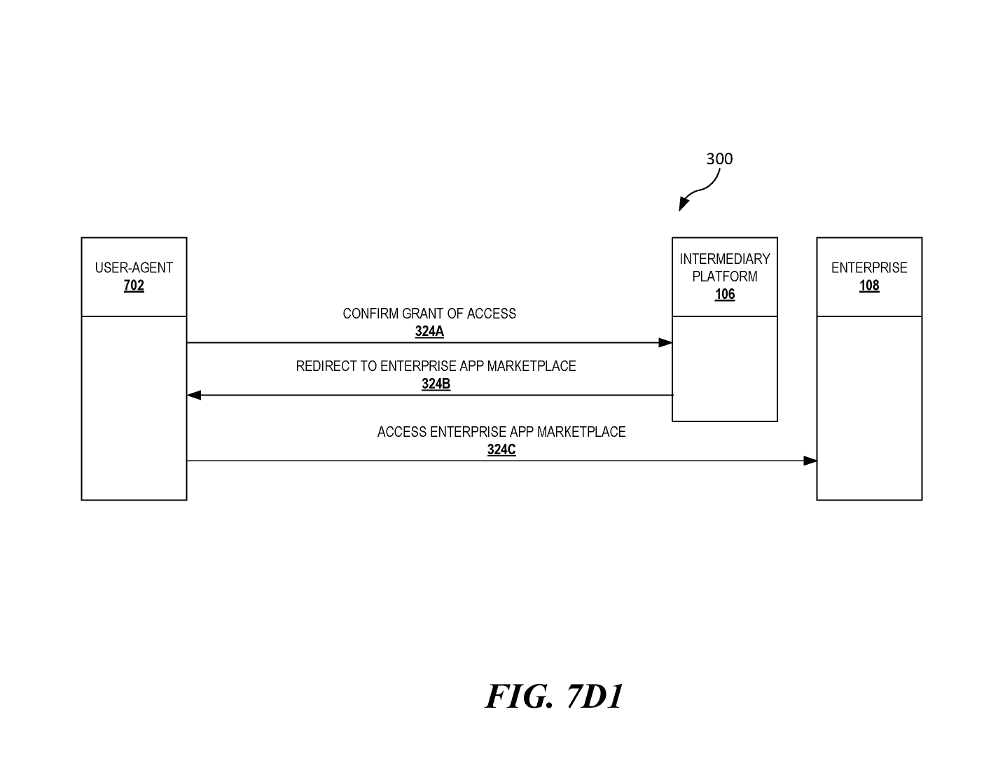

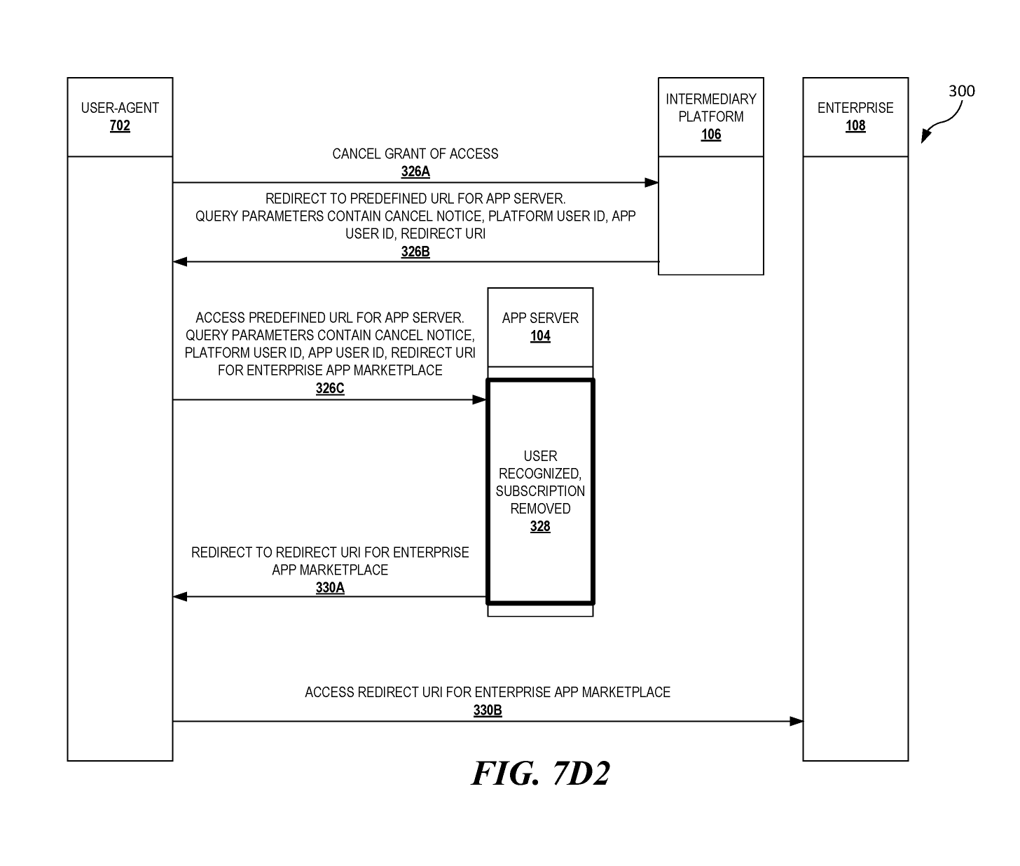

Referring to FIGS. 7A-7D2, depicted is method 300 with additional details. User-agent 702 and individual messages between network devices are shown. In particular, steps in FIG. 3 where user-agent 702 is redirected are shown as two steps in FIGS. 7A-7D2. In the first step, user-agent 702 may receive a “redirect” message from another network device. The redirect message may be a HTTP response to a HTTP GET request in the preceding step. The redirect message may contain a URI that user-agent 702 is redirected to. The redirect message may also contain any query parameters that user-agent 702 is to send to the URI. In the second step, user-agent 702 may access the URI by sending an “access” message (for example, a HTTP GET request) to the URI with the query parameters. Steps 304A, 308A, 312A, 316A, 320A, and 324B involve redirect messages. Steps 304B, 308B, 312B, 316B, 320B, and 324C involve access messages.

At step 310A, app server 104 may respond to a HTTP GET request sent at step 308B. App server 104 may send a web page containing a form for the user to enter one or more authentication credentials, or to create an account. At step 310B, the user may enter the authentication credentials or create the account. User-agent 702 may send a HTTP GET request containing the authentication credentials or creating the account.

Similarly, at step 322, intermediary platform 106 may respond to a HTTP GET request sent at step 320B. Intermediary platform 106 may send user-agent 702 a web page containing a form for the user to confirm or cancel the grant of access to app data. At step 324A, the user may choose to confirm the grant of access, and user-agent 702 may send a HTTP GET request representing the confirmation. At step 324B, the user may choose to cancel the grant of access, and user-agent 702 may send a HTTP GET request representing the cancellation.

FIGS. 7A-7D2 show the use of query parameters, but method 300 may also use alternatives such as HTTP POST requests with parameters in the body of the request. Step 404 in method 400 may performed as shown in steps 304A and 304B.

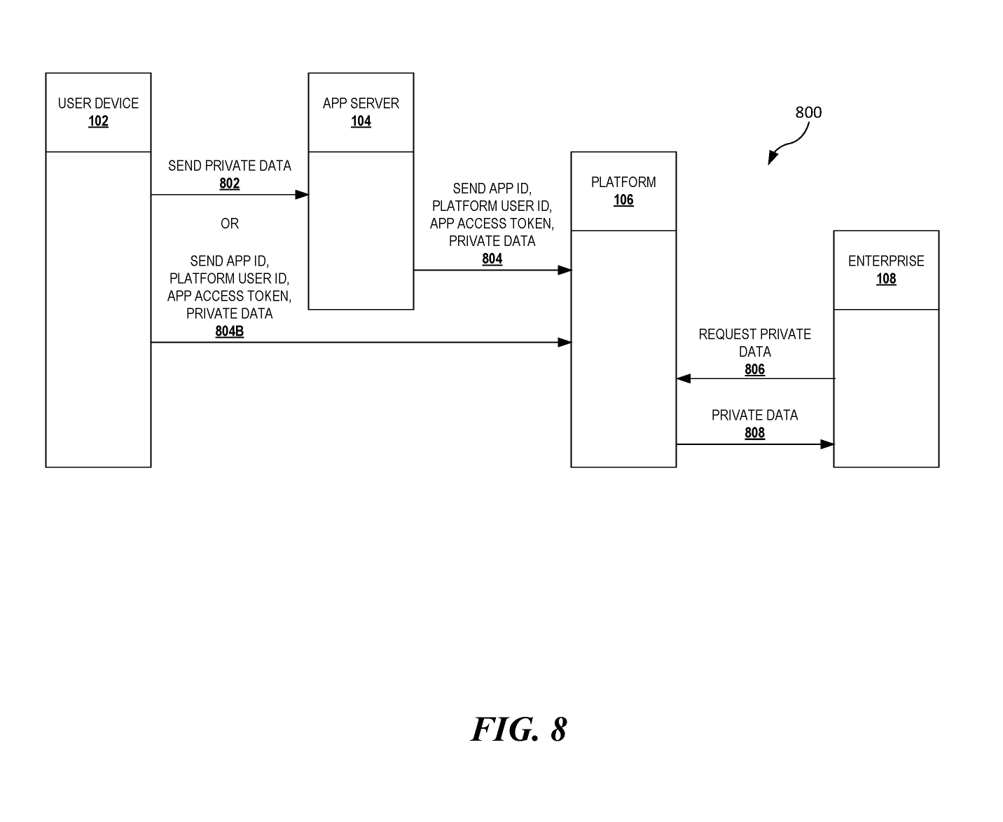

Referring to FIG. 8, depicted is a method 800 for sending private data after a subscription has been created in method 300 or method 400. At step 802, user device 102 may send private data to app server 104. At step 804, in response to the subscription and the receiving of the private data, app server 104 may send a HTTP POST request containing the app ID, platform user ID, app access token, and private data to intermediary platform 106. At step 806, enterprise 108 may request the user's private data from platform 106. At step 808, platform 106 may send the private data to enterprise 108.

As an alternative to steps 802 and 804, at step 804B user device 102 may send private data directly to intermediary platform 106. User device 102 may send a HTTP POST request containing the app ID, platform user ID, app access token, and private data to intermediary platform 106.

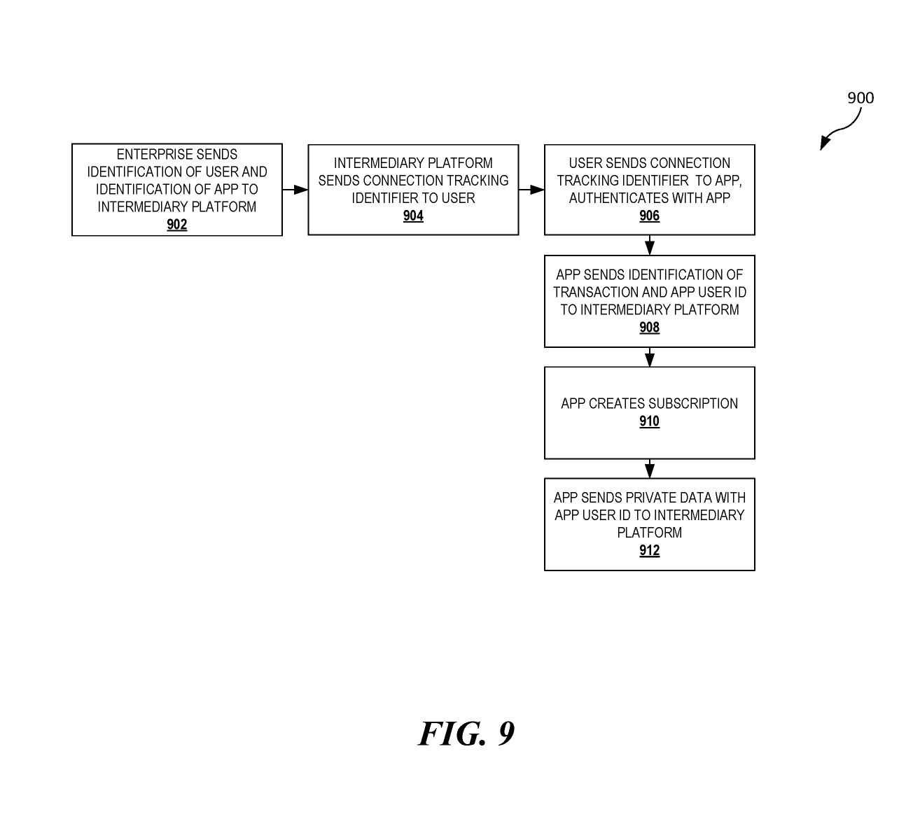

Referring to FIG. 9, depicted is a general method 900 for authenticating data transfer. At step 902, enterprise 108 may send an identification of a user and an identification of an app to intermediary platform 106. The enterprise may perform step 902 by redirecting a user-agent as in steps 304 or 404. At step 904, the intermediary platform may send a connection tracking identifier to the user. The connection tracking identifier may be a tracking signature, as in method 300, or a connection PIN, as in method 400.

At step 906, the user may send the connection tracking identifier to the app. Step 906 may be performed automatically through redirection, as in step 308, or manually, as in step 410. The app may be running on app server 104, user device 102, or both. At 906, the user may also authenticate with the app. The authentication may be performed by providing one or more authentication credentials or creating an account, as in method 300. Alternately, if the user sends the connection tracking identifier manually, the sending of the connection tracking identifier may be considered the authentication, as in method 400.

At step 908, the app may send the identification of the transaction to intermediary platform 106. The app may also send an app user ID (identification of the user to the app) to intermediary platform 106. At step 910, the app may create a subscription of intermediary platform 106 to the user's private data. At step 912, in response to the subscription, the app may send the user's private data to intermediary platform 106. The app may also send the app user ID sent at 908, thereby identifying the user associated with the data.

As an alternative to the app sending an app user ID to intermediary platform 106 at 908, intermediary platform 106 may send a platform user ID (identification of the user to the intermediary platform) to the app. The intermediary platform may send the platform user ID with or as part of the connection tracking identifier at step 904, or may send the platform user ID to the app in response to step 908. At step 912, the app may send the platform user ID to identify the user associated with the data. Intermediary platform 106 may adopt the identification of the user by enterprise 108 at step 902 as the platform user ID.

It is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of various embodiments.

We claim:

1. A method for authenticating data transfer, the method comprising:
an enterprise redirecting a user-agent to an intermediary platform, the redirecting comprising sending a message to the user-agent comprising an enterprise user authentication token and an application identifier;
the intermediary platform sending a connection PIN to the user-agent;
an application receiving the connection PIN;
the intermediary platform receiving an application user identifier, the connection PIN, and a callback URL; and
the intermediary platform sending a platform user identifier and the application user identifier to the callback URL.

2. The method of claim 1, further comprising the intermediary platform sending a notification to the enterprise, the notification identifying a user and an application the application server is associated with.

3. The method of claim 1, further comprising the intermediary platform sending a platform user authentication token to the callback URL.

4. The method of claim 1, wherein the connection PIN comprises a series of alphanumeric characters.

5. The method of claim 1, wherein the intermediary platform receives the application user identifier, the connection PIN, and the callback URL from a user device.

6. The method of claim 1, wherein the intermediary platform receives the application user identifier, the connection PIN, and the callback URL from an application server.

7. The method of claim 1, further comprising creating a subscription of the intermediary platform to data of the user.
